(19) United States
(12) Patent Application Publication
(10) Pub. No.: US 2017/0139656 A1
(43) Pub. Date: May 18, 2017

(54) STREAMING A WALKTHROUGH FOR AN APPLICATION OR ONLINE SERVICE

(71) Applicant: salesforce.com, inc., San Francisco, CA (US)

(72) Inventors: Heather Nicole Sterling, Raleigh, NC (US); Ryan Eric Smith, Durham, NC (US); Joel Benjamin Allen, Mebane, NC (US)

(21) Appl. No.: 14/942,188

(22) Filed: Nov. 16, 2015

(51) Int. Cl. G06F 3/14; G06F 3/0484; H04L 29/06; G06F 9/44

(52) U.S. Cl. CPC G06F 3/14; G06F 9/4446; G06F 3/0484; H04L 65/4069

(57) ABSTRACT

Disclosed are examples of systems, apparatus, methods and computer program products for streaming a walkthrough for an application or an online service. A database storing data objects identifying walkthroughs and walkthrough stages can be maintained. A request can be received from a first computing device of an author of a first walkthrough. A first walkthrough stage of the first walkthrough can be generated. The first walkthrough stage can comprise an interactive demonstration of a first feature of the application or online service. The first walkthrough stage can be caused to be displayed in a first user interface at a second computing device of a user interacting with the first walkthrough. Input can be received from the second computing device. It can be determined that the user has performed an interaction with the first feature. A visual indicator can be caused to be displayed in a second user interface at the first computing device. The visual indicator can indicate that the user has performed the interaction with the first feature.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to walkthroughs for applications or online services. More specifically, this patent document discloses techniques for streaming a walkthrough for an application or an online service.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

### BRIEF DESCRIPTION OF THE DRAWINGS

The included drawings are for illustrative purposes and serve only to provide examples of possible structures and operations for the disclosed inventive systems, apparatus, methods and computer program products for streaming a walkthrough for an application or an online service. These drawings in no way limit any changes in form and detail that may be made by one skilled in the art without departing from the spirit and scope of the disclosed implementations.

FIG. 1 shows a flowchart of an example of a method 100 for streaming a walkthrough for an application or an online service, performed in accordance with some implementations.

FIG. 2 shows a block diagram of an example of a Walkthrough Database 200, in accordance with some implementations.

FIGS. 3A-B show examples of presentations of walkthrough stages in the form of graphical user interfaces (GUIs) as displayed on a computing device, in accordance with some implementations.

FIG. 4 shows an example of a computing environment in which some of the disclosed techniques may be practiced, in accordance with some implementations.

FIG. 5A shows a block diagram of an example of an environment 10 in which an on-demand database service can be used in accordance with some implementations.

FIG. 5B shows a block diagram of an example of some implementations of elements of FIG. 5A and various possible interconnections between these elements.

FIG. 6A shows a system diagram of an example of architectural components of an on-demand database service environment 900, in accordance with some implementations.

FIG. 6B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for streaming a walkthrough for an application or an online service. The concept of walkthroughs as discussed herein encompasses a range of subject matter. A walkthrough generally refers to an interactive presentation for training a user to use any computing application or online service such as, but not limited to, a cloud-based enterprise application. A walkthrough can include a variety of segments or portions, referred to herein as walkthrough stages. In some implementations, a walkthrough can be provided using a server-based database system to deliver hands-on training to employees, customers, or other individuals at their computing devices. By way of illustration, such hands-on training can merge interactive e-learning tutorials with guided exercises within the same training application.

Streaming a walkthrough, e.g. providing the walkthrough to users while the walkthrough is being authored, can be a valuable training tool. However, streaming walkthroughs using conventional techniques can be difficult. By way of illustration, Catherine is Chief Executive Officer (CEO) of Northanger Books, an online book retailer that is completely overhauling their web page. As such, Catherine faces the challenge of demonstrating hundreds of new features of Northanger Books' web page, such as record types, buttons, fields, etc., to thousands of investors and customers. Catherine wishes to stream these walkthroughs to her customers and investors in order to receive live feedback while users interact with the walkthroughs, allowing her to monitor users' progress and identify potential problem areas. Unfortunately, traditional walkthrough authoring tools do not allow authors to stream walkthroughs.

Some of the disclosed techniques can be used to allow walkthrough authors to stream a walkthrough while it is being authored. Returning to the example of the preceding paragraph, Henry, head of software development at Northanger Books, authors a first walkthrough stage. As described below, a database system can generate the first walkthrough stage, causing the first walkthrough stage to be displayed on the computing device of James, a Northanger Books customer. As described below, when James completes the first walkthrough stage, the database system can cause a visual indicator to be displayed on Henry's computing device. The visual indicator can indicate to Henry that James has completed the first walkthrough stage, allowing Henry to quickly, accurately, and effectively monitor James' progress. In some implementations, the database system can provide Henry with analytic information summarizing James' and other users' usage patterns when interacting with the walkthrough, as described below. As such, Henry can get Northanger Books' customers up to date with the new web page by providing individually-tailored support to customers.

In some implementations, streamed walkthroughs can be tolerant to interruptions. By way of example, James is in the midst of completing an “ordering walkthrough” which demonstrates how to order books from the Northanger Books web page using his desktop computer. There is a sudden power outage and James' connection to the internet is lost. As described below, an interaction history can be stored locally on James' desktop computer. As such, when James' internet connection is restored, he can pick up where he left off at the last stage of the ordering walkthrough that he completed before the power outage.

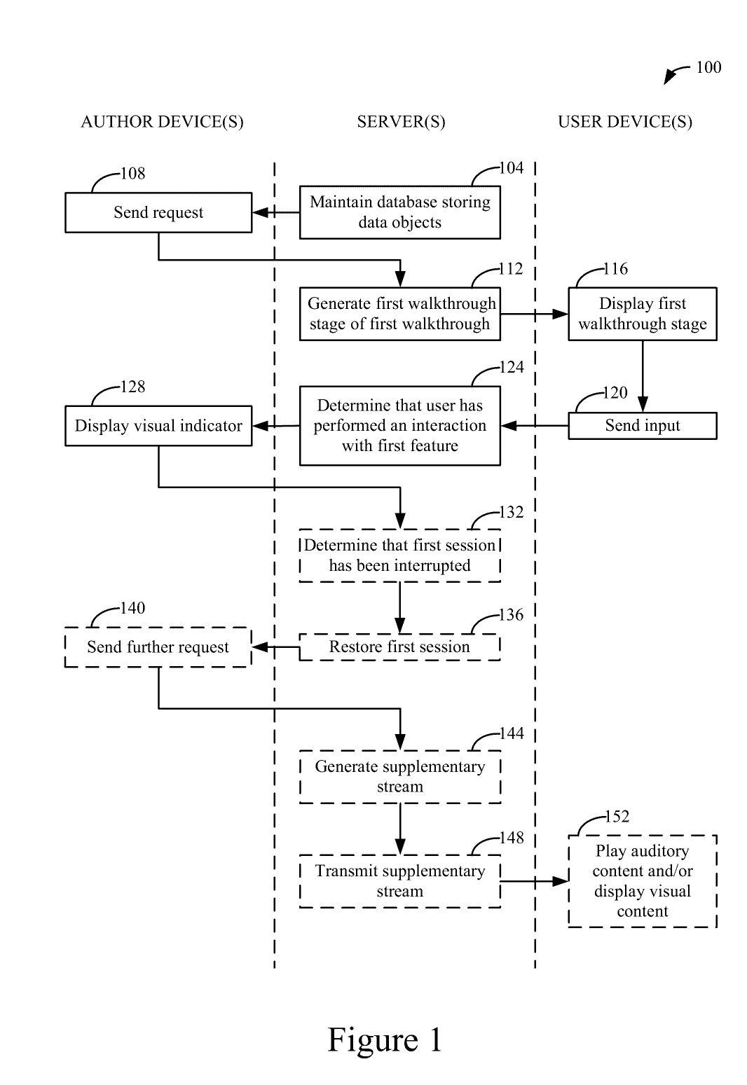

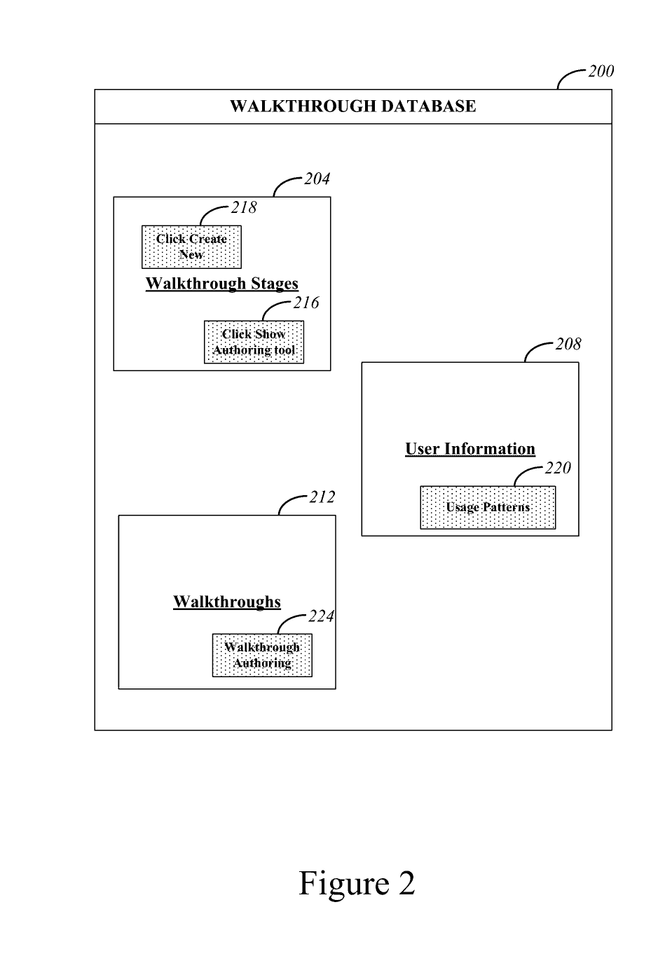

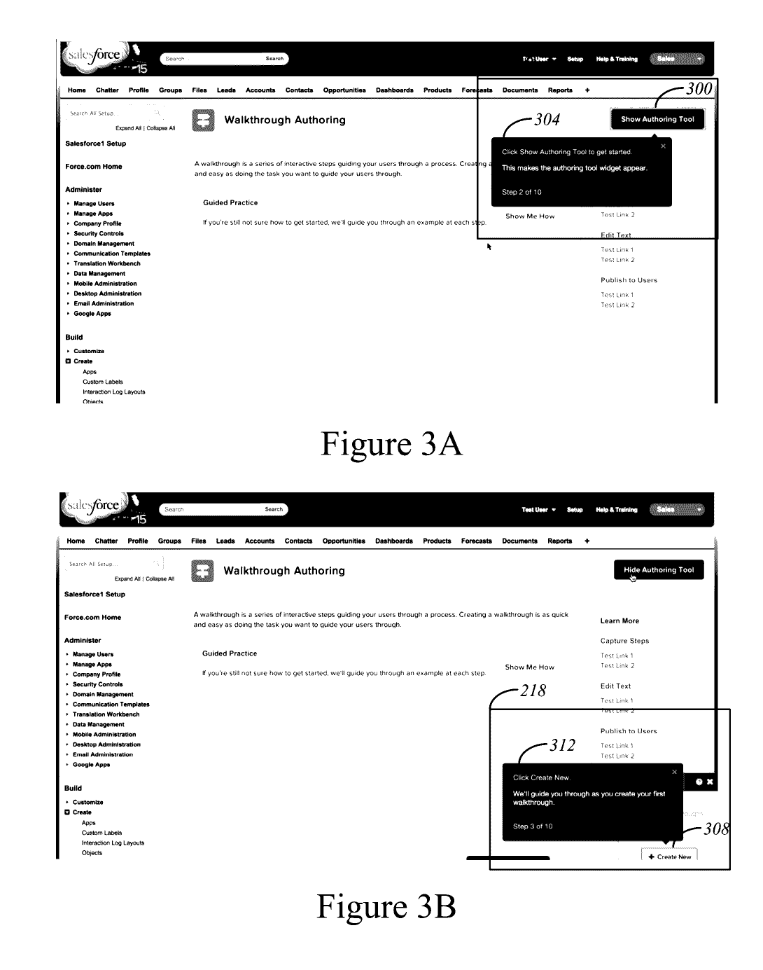

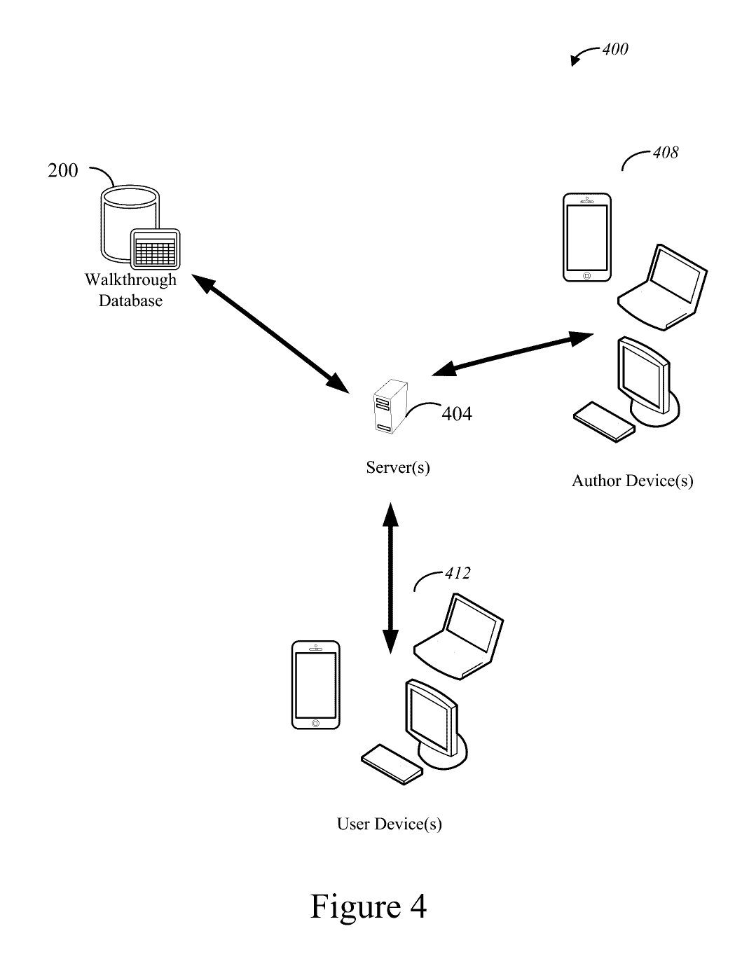

FIG. 1 shows a flowchart of an example of a method 100 for streaming a walkthrough for an application or an online service, performed in accordance with some implementations. FIG. 2 shows a block diagram of an example of a Walkthrough Database 200, in accordance with some implementations. FIGS. 3A-B show examples of presentations of walkthrough stages in the form of graphical user interfaces (GUIs) as displayed on a computing device, in accordance with some implementations. FIG. 4 shows an example of a computing environment in which some of the disclosed techniques may be practiced, in accordance with some implementations.

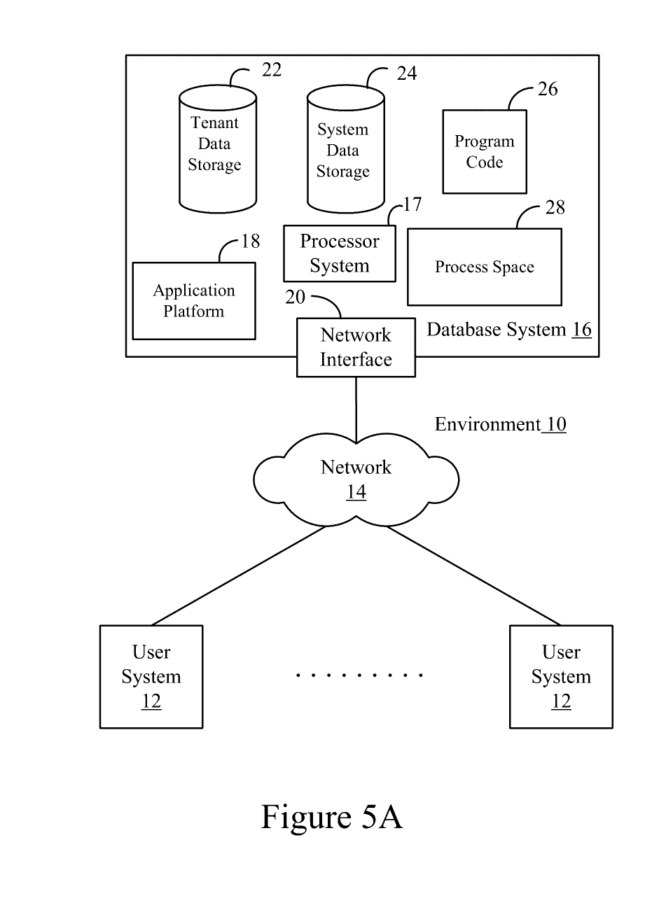

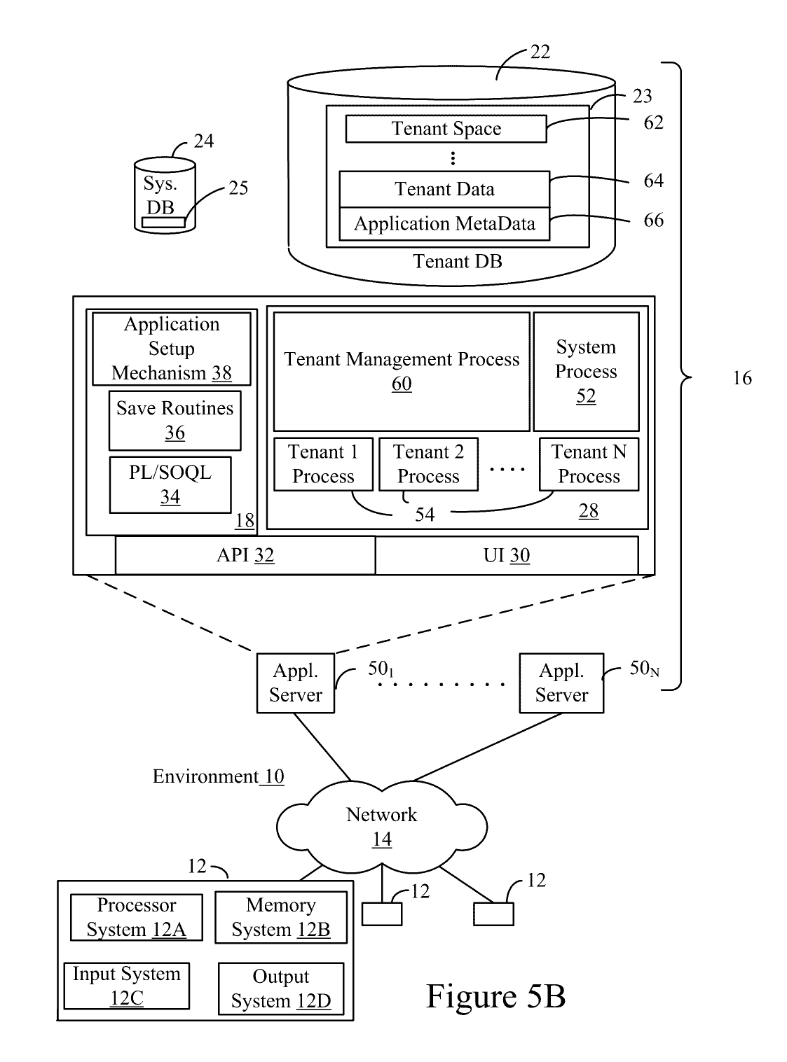

At 104 of FIG. 1, Walkthrough Database 200 of FIG. 2 is maintained. Walkthrough Database 200 can be maintained by servers, such as Server(s) 404 of FIG. 4, on behalf of an organization such as Northanger Books, by a third party such as salesforce.com, inc., or both. For example, Walkthrough Database 200 can form part of a database system 16 of FIGS. 5A and 5B. In some cases, walkthrough data can be stored in tenant data storage 22, described in greater detail below. Walkthrough Database 200 can store a wide variety of customizable data objects. For example, in FIG. 2, some data objects in Walkthrough Database 200 might identify walkthrough stages 204. Walkthrough stages 204, which, as described above, are segments or portions of a walkthrough, can contain both pre-defined walkthrough stages and user-defined walkthrough stages. Specific types of walkthrough stages can vary across implementations. For instance, Click Show Authoring Tool 216 is an example of a walkthrough stage that demonstrates how and when to click or tap Show Authoring Tool Button 300 of FIG. 3A as part of the Walkthrough Authoring 224 walkthrough, as described in more detail below. Click Create New 218, which demonstrates how and when to click or tap Create New Button 308 of FIG. 3B as part of the Walkthrough Authoring 224 walkthrough is another example of a walkthrough stage 204 stored in Walkthrough Database 200.

A walkthrough stage can be defined by a variety of data, such as a target, a label, start and/or completion criteria, etc., which can be stored in Walkthrough Database 200. By way of illustration, Click Show Authoring Tool 216 targets Show Authoring Tool Button 300 of FIG. 3A. Additionally, Click Show Authoring Tool 216 is labeled by text box 304. Also or alternatively, a walkthrough stage can be defined by start criteria, which specify the conditions under which a walkthrough stage is displayed, and completion criteria, which specify when the stage is not displayed. By way of illustration, Click Show Authoring Tool 216 is the second walkthrough stage in the Walkthrough Authoring 224 walkthrough; therefore, the start criterion for Click Show Authoring Tool 216 is met when the preceding stage in the Walkthrough Authoring 224 walkthrough is completed. The completion criterion for Click Show Authoring Tool 216 can be met when its target, Show Authoring Tool Button 304 of FIG. 3A, is clicked or tapped by a user.

Along the same lines, the walkthrough stage Click Create New 218, targets Create New Button 308 of FIG. 3B and is labeled by text box 312. Since Click Create New 218 is immediately preceded by Click Show Authoring Tool 216 in Walkthrough Authoring 224, the completion criterion for Click Show Authoring Tool 216 is also the start criterion for Click Create New 218. In other words, Click Create New 218 begins when Click Show Authoring Tool 216 is completed. The completion criterion for Click Create New 218 can be met when Create New Button 308 of FIG. 3B is clicked or tapped by a user.

Returning to FIG. 2, some data objects in Walkthrough Database 200 can identify User Information 208, such as Usage Patterns 220. User Information 208 can vary across implementations and are described in further detail below. For example, Usage Patterns 220 can include data relating to user interactions with walkthroughs such as Walkthrough Authoring 224. By way of illustration, a usage pattern for Henry, may include data indicating the number of times Henry has completed each stage of Walkthrough Authoring 224, the amount of time Henry has taken to complete each stage, records of actions made by Henry as he interacts with each stage of Walkthrough Authoring 224, such as clicking a button, entering text in a field, moving a mouse cursor over a feature of an application or service, selecting a menu item, etc.

In some implementations, some data objects in Walkthrough Database 200 might also identify walkthroughs 212 such as Walkthrough Authoring 224. Walkthrough Authoring 224 is a walkthrough demonstrating how to author walkthroughs. Also or alternatively, a walkthrough might demonstrate features relating to Customer Relationship Management (CRM) records, such as an account, a task, a lead, a contact, a contract or an opportunity, or another type of data object.

Returning to FIG. 1, at 108, a request is sent from Author Device(s) 408 to Server(s) 404 of FIG. 4. As described below, the request can indicate that a user of Author Device(s) 408 has requested to generate a walkthrough stage. Author Device(s) 408 can be any type or combination of computing devices that can be used to author a walkthrough for an application or online service. For instance, Author Device(s) 408 can access tools for authoring walkthroughs such as such as the walkthrough authoring tool provided by salesforce.com, inc. Some examples of Author Device(s) 408 can include a desktop computer, a laptop, a tablet, a smartphone, a television set-top box, or wearable device such Google Glass® or other human body-mounted display apparatus.

Requests received at 108 of FIG. 1 can vary across implementations. By way of illustration, Henry may be using his iPad® to author the walkthrough stage Click Show Authoring Tool 216 of FIG. 2 and add Click Show Authoring Tool 216 to the Walkthrough Authoring 224 walkthrough. In response to Henry finishing his authoring of the walkthrough stage Click Show Authoring Tool 216 by clicking or tapping a “complete stage” button on his iPad®, Henry's iPad® can transmit a request over the internet in the form of data to Server(s) 404 of FIG. 4, which are in communication with Walkthrough Database 200. Such data can indicate that Henry has requested to add Click Show Authoring Tool 216 of FIG. 2 to the Walkthrough Authoring 224 walkthrough.

At 112 of FIG. 1, a walkthrough stage is generated based on the request received at 108. By way of example, Server(s) 404 of FIG. 4 can generate the walkthrough stage Click Show Authoring Tool 216 of FIG. 2 based on Henry's request to add Click Show Authoring Tool 216 to the Walkthrough Authoring 224 walkthrough described in the preceding paragraph.

At 116 of FIG. 1, the walkthrough stage Click Show Authoring Tool 216 of FIG. 3A is displayed in a user interface at User Device(s) 412 of FIG. 4. User Device(s) 412 can be any type or combination of computing devices that are capable of displaying stages of a walkthrough for an application or online service. For example, User Device(s) 412 can include a desktop computer, a laptop, a tablet, a smartphone, a television set-top box, or wearable device such Google Glass® or other human body-mounted display apparatus.

In some implementations, a database system can cause a walkthrough stage to be displayed in a user interface at User Device(s) 412 in response to the first walkthrough stage being generated at 112 of FIG. 1. By way of example, Server(s) 404 of FIG. 4 can be configured to transmit data to Catherine's iPhone®, causing Click Show Authoring Tool 216 of FIG. 3A to be displayed in a browser window on a display of Catherine's iPhone®.

In some implementations, a walkthrough stage can be displayed on more than one user device. By way of illustration, Catherine wishes to stream a walkthrough demonstrating new features of the Northanger Books web site to the major shareholders of Northanger Books. As such, Catherine can generate the first stage of the walkthrough using the techniques described above in the context of 104-112 of FIG. 1. Once the first stage of the walkthrough is generated, Server(s) 404 can transmit data via the internet to the computing devices of each the major shareholders of Northanger Books, causing the first stage to be displayed in a user interface at the displays of each of the computing devices of the major shareholders of Northanger Books.

Returning to FIG. 1, at 120, input is sent from User Device(s) 412 of FIG. 4 to Server(s) 404. In some implementations, such input may reflect a user interaction with a walkthrough stage. By way of illustration, Catherine may complete the Click Show Authoring Tool 216 stage of the Walkthrough Authoring 224 walkthrough on her iPhone®. Catherine's iPhone can send data to Server(s) 404 indicating that Catherine has completed the Click Show Authoring Tool 216 stage of the Walkthrough Authoring 224 walkthrough.

At 124 of FIG. 1, it is determined that a user of User Device(s) 412 of FIG. 4 has performed an interaction with the Click Show Authoring Tool 216 stage of the Walkthrough Authoring 224 walkthrough of FIG. 2. By way of illustration, returning to the example of the preceding paragraph, Server(s) 404 can process the input received at 120 of FIG. 1 of FIG. 1 to determine that Catherine has completed the Click Show Authoring Tool 216 stage of the Walkthrough Authoring 224 walkthrough.

At 128 of FIG. 1, a visual indicator can be displayed on Author Device(s) 408 of FIG. 4. By way of example, in response to determining that Catherine has completed the Click Show Authoring Tool 216 stage of the Walkthrough Authoring 224 walkthrough of FIG. 2, Server(s) 404 can transmit data to Henry's iPad®, causing Henry's iPad® to display a pop-up message indicating that Catherine has completed the Click Show Authoring Tool 216 stage of the Walkthrough Authoring 224 walkthrough.

Also or alternatively, a variety of other visual or auditory indicators can be caused to be displayed or played on Author Device(s) 408 to indicate user interactions with walkthrough stages. Returning to the example of the preceding paragraph, Henry's iPad® can emit a buzz/beep or display a green circle in conjunction with, or separately from, the pop-up message to indicate that Catherine has completed the Click Show Authoring Tool 216 stage of the Walkthrough Authoring 224 walkthrough. Alternatively, a red circle may be caused to be displayed on Henry's iPad® to notify him that a user has attempted to complete a walkthrough stage incorrectly.

In some implementations, User Device(s) 412 of FIG. 4 can send a variety of feedback to Author Device(s) 408 by way of Server(s) 404 when a user completes walkthrough stage. For example, as discussed in the preceding paragraphs, a visual indicator can be displayed that notifies a walkthrough author when a user completes a walkthrough stage. Such feedback can allow an author of a walkthrough to be aware of a user's progress in the walkthrough and observe how long it takes for a user to complete a given stage of a walkthrough.

Also or alternatively, such feedback can include detailed analytic information allowing an author of a walkthrough to better understand usage patterns of a user interacting with the walkthrough. By way of example, as described above, Walkthrough Database 200 of FIG. 2 can store data objects identifying Usage Patterns 220. In some implementations, Usage Patterns 220 can be processed by Server(s) 404 of FIG. 4 to generate analytic information. Such analytic information can illustrate a summary of a usage pattern of a user of a walkthrough. By way of illustration, Henry's usage pattern that is stored in Walkthrough Database 200 indicates the amount of time Henry has taken to complete each stage of the Walkthrough Authoring 224 walkthrough. Henry's usage pattern can be processed by Server(s) 404 of FIG. 4 to generate analytic information indicating a mean, median, and mode amount of time that Henry has taken per stage when completing the Walkthrough Authoring 224 walkthrough.

Also or alternatively, such analytic information can be generated based on an aggregated summary of usage patterns of several users of a walkthrough. By way of example, usage patterns of all users who have interacted with Walkthrough Authoring 224 walkthrough of FIG. 2 can be processed by Server(s) 404 of FIG. 4 to generate analytic information indicating a mean amount of time that users' mouse cursors hover over Show Authoring Tool Button 304 of FIG. 3A before clicking Show Authoring Tool Button 304 when completing the Click Show Authoring Tool 216 stage of the Walkthrough Authoring 224 walkthrough of FIG. 2.

In some implementations, analytic information can be indicated to a walkthrough author by way of a further visual indicator that is displayed in a user interface at Author Device(s) 408 of FIG. 4. By way of example, text can be displayed in a browser window on Henry's iPad® that indicates a mean amount of time that is spent by users in completing each stage of the Walkthrough Authoring 224 walkthrough of FIG. 2.

In some implementations, when a authorship of a walkthrough is completed by an author, the walkthrough can be stored in Walkthrough Database 200 of FIG. 2. By way of example, when Henry clicks or taps a button on his iPad® to indicate that he has completed the Walkthrough Authoring 224 walkthrough, Henry's iPad® can send data to Server(s) 404 of FIG. 4. Server(s) 404 can process the data and cause the Walkthrough Authoring 224 walkthrough to be stored as a data file in Walkthrough Database 200. Walkthrough Authoring 224 can then be accessed via the internet and interacted with by users of Walkthrough Database 200.

In some implementations, records of user interactions with walkthrough stages can be stored locally on User Device(s) 412 of FIG. 4. By way of example, data can be stored locally on Catherine's iPhone® when she taps Show Authoring Tool Button 300 to complete the walkthrough stage Click Show Authoring Tool 216. Also or alternatively, such data can be a component of an interaction history. By way of example, each time Catherine interacts with the Walkthrough Authoring 224 walkthrough, data describing a record of each interaction can be stored locally on her iPhone®. The data can form a part of a history of Catherine's interactions with the Walkthrough Authoring 224 walkthrough. At a given time, the interaction history can indicate the stages of the Walkthrough Authoring 224 walkthrough that Catherine has completed, the stage with which she is currently interacting, and the stages which she is yet to complete.

In some but not all implementations, at 132 of FIG. 1, it can be determined that a walkthrough session between User Device(s) 412 and Server(s) 404 of FIG. 4 has been interrupted. As used herein, a “walkthrough session” between a user device and a server generally refers to a period of activity during which the user interacts with the walkthrough. By way of example, Catherine has initiated a walkthrough session on her iPhone® and is in the midst of completing the walkthrough stage Click Show Authoring Tool 216 of FIG. 2 during her morning commute ride on a light rail train. The train passes through a tunnel, causing Catherine's smartphone to lose reception and disconnect from the internet, breaking communication between her smartphone and Server(s) 404. As such, Server(s) 404 can determine that communication between Catherine's smartphone and Server(s) 404 has been broken and that the walkthrough session has been interrupted.

In some but not all implementations, at 136 of FIG. 1, the walkthrough session is restored. Returning to the example of the preceding paragraph, Catherine's train leaves the tunnel, her internet connection is restored, and communication between her smartphone and Server(s) 404 of FIG. 4 is reestablished. As such, the interaction history described above that is stored locally on Catherine's smartphone can be used by Catherine's smartphone to restore the walkthrough session. Since the interaction history stored on Catherine's smartphone indicates that Catherine was interacting with the walkthrough stage Click Show Authoring Tool 216 of FIG. 2 before the walkthrough session was interrupted, Catherine can quickly pick up where she left off.

In some but not all implementations, at 140 of FIG. 1, a further request is sent from Author Device(s) 408 to Server(s) 404 of FIG. 4. The further request can reflect a walkthrough author's request to supplement a walkthrough with additional content such as auditory or visual content related to the walkthrough. Such additional content is referred to herein as a supplementary stream. By way of example, Henry may wish to generate a supplementary stream that includes auditory content that explains the importance of a walkthrough stage. Also or alternatively, a supplementary stream can include an auditory description of a walkthrough stage to enable the walkthrough stage to be completed by blind or other handicapped users.

Also or alternatively, a supplementary stream can include visual content to augment a walkthrough stage. By way of example, a red exclamation mark can be displayed on a user device in conjunction with a walkthrough stage in order to emphasize the importance of the walkthrough stage.

In some implementations, a supplementary stream may be a live video stream provided by a walkthrough author. By way of illustration, Henry may wish to stream the Walkthrough Authoring 224 walkthrough of FIG. 2. Henry may also receive questions from users while the users are completing the Walkthrough Authoring 224 walkthrough. For instance, User Device(s) 412 of FIG. 4 can send such questions in the form of text or video to Author Device(s) 408 by way of Server(s) 404. As such, Henry can provide answers questions as they come up by way of a supplementary stream that contains a live (or prerecorded) video stream in which Henry answers the questions.

In some but not all implementations, at 144 of FIG. 1, the supplementary stream is generated based on the further request sent at 140. By way of illustration, Server(s) 404 of FIG. 4 can process visual and/or audio data received from Henry's iPad® to generate the supplementary stream.

In some but not all implementations, at 148 of FIG. 1, the supplementary stream is transmitted by Server(s) 404 of FIG. 4 to User Device(s) 412 and at 152 of FIG. 1, the supplementary stream is processed by User Device(s) 412 to play the auditory content, display the visual content, or both. By way of illustration, Catherine's smartphone can play and/or display a supplementary stream in conjunction with the Walkthrough Authoring 224 walkthrough of FIG. 2.

In some implementations, a preview of a walkthrough can be generated and a presentation of the preview can be provided to a computing device. By way of example, Eleanor may be supervising Henry while Henry Authors the Walkthrough Authoring 224 walkthrough. As such, when Henry completes the Walkthrough Authoring 224 walkthrough, Server(s) 404 can transmit data over the internet to Eleanor's computing device, causing Eleanor's computing device to display a preview of the Walkthrough Authoring 224 walkthrough. Eleanor might click or tap a button in the user interface of her computing device, requesting to view the preview. Server(s) 404 can provide data to Eleanor's computing device which can be processed by a processor of Eleanor's computing device to display a presentation of the preview. Eleanor can then interact with the preview to validate or modify the walkthrough, as described further below.

In some implementations, one might view a presentation of a preview and decide to modify or validate a walkthrough. Returning to the example of the preceding paragraph, if Eleanor views the preview and notices that some text in the preview is inaccurate, she can request to modify the Walkthrough Authoring 224 walkthrough by editing the inaccurate text. The Walkthrough Authoring 224 walkthrough can then be modified according to Eleanor's request and the modified walkthrough can be stored in Walkthrough Database 200.

In some implementations, the disclosed techniques can be used to stream walkthroughs in a variety of contexts, such as an academic setting. By way of illustration, Professor Tilney teaches a statistics course which relies on a statistical software package. Professor Tilney can demonstrate various features of the statistical software package to his students by authoring walkthrough stages demonstrating such features and receiving feedback as his students interact with the walkthrough stages, as described above in the context of 104-128 of FIG. 1. Henry can identify problem areas and tailor his teaching to the needs of his students using the feedback and by analyzing his students' usage patterns, as discussed above.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

FIG. 5A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 5A (and in more detail in FIG. 5B) user systems 12 might interact via a network 14 with an on-demand database service, which is implemented in the example of FIG. 5A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 5A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 5A and 5B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 5A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 5B shows a block diagram of an example of some implementations of elements of FIG. 5A and various possible interconnections between these elements. That is, FIG. 5B also illustrates environment 10. However, in FIG. 5B elements of system 16 and various interconnections in some implementations are further illustrated. FIG. 5B shows that user system 12 may include processor system 12A, memory system 12B, input system 12C, and output system 12D. FIG. 5B shows network 14 and system 16. FIG. 5B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 5A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 5B, system 16 may include a network interface 20 (of FIG. 5A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

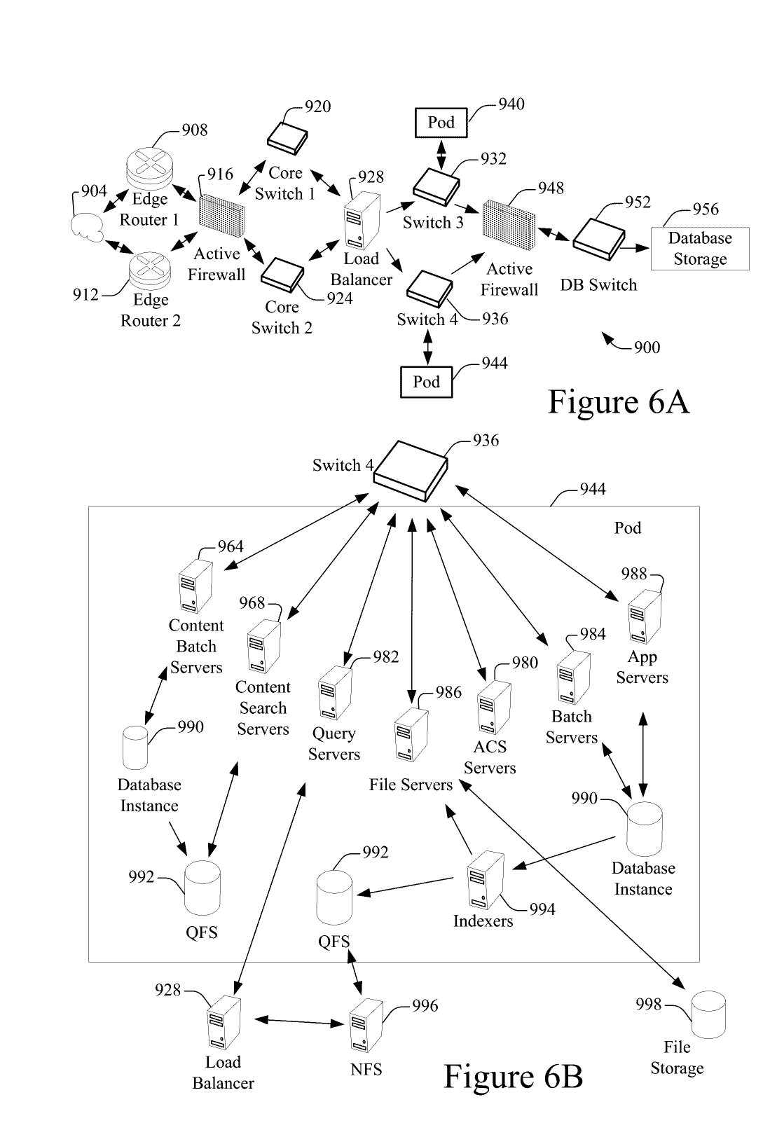

FIG. 6A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 6A and 6B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 6A and 6B, some implementations of an on-demand database service environment may include anywhere from one to many devices of each type. Also, the on-demand database service environment need not include each device shown in FIGS. 6A and 6B, or may include additional devices not shown in FIGS. 6A and 6B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 6B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 6A and 6B.

FIG. 6B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to execute operations of the services described herein, including performance of one or more of the operations of methods described herein with reference to FIGS. 1-4. In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system for streaming a walkthrough for an application or an online service, the system comprising:
a database storing data objects identifying walkthroughs and walkthrough stages, each walkthrough comprising a plurality of sequentially ordered walkthrough stages, each walkthrough stage configured to be displayed in a user interface at a computing device and each walkthrough stage comprising at least a portion of an interactive demonstration of a feature of the application or online service; and
one or more servers in communication with the database, the one or more servers comprising one or more processors operable to cause:
generating, based on a request received over a data network from a first computing device of an author of a first walkthrough, a first walkthrough stage of the first walkthrough, the first walkthrough stage comprising an interactive demonstration of a first feature of the application or online service;
displaying, responsive to generating the first walkthrough stage, the first walkthrough stage in a first user interface at a second computing device of a user interacting with the first walkthrough;
determining, responsive to receiving input over a data network from the second computing device, that the user has performed an interaction with the first feature; and
displaying, responsive to determining that the user has performed the interaction with the first feature, a visual indicator in a second user interface at the first computing device, the visual indicator indicating that the user has performed the interaction with the first feature.

2. The system of claim 1, the one or more processors further operable to cause:
storing, on the second computing device and responsive to determining that the user has performed the interaction with the first feature, data indicating that the user has performed the interaction with the first feature.

3. The system of claim 2, wherein the data indicating that the user has performed the interaction with the first feature is a component of an interaction history stored on the second computing device, the interaction history comprising further data indicating a history of a plurality of interactions with features of the application or online service.

4. The system of claim 3, the one or more processors further operable to cause:
determining that a first walkthrough session associated with the second computing device and one of the servers has been interrupted; and
restoring, using the interaction history and responsive to determining that the first session has been interrupted, the first walkthrough session.

5. The system of claim 1, the one or more processors further operable to cause:
storing, in the database, one or more data objects identifying a usage pattern associated with the user.

6. The system of claim 5, the one or more processors further operable to cause:
processing the usage pattern to generate analytic information indicating a summary of the usage pattern; and
displaying a further visual indicator indicating the analytic information in the second user interface at the first computing device of the author of the walkthrough.

7. The system of claim 1, the one or more processors further operable to cause:
generating, based on a further request received from the first computing device of the author of the first walkthrough, a supplementary stream comprising one or both of: auditory or visual content relating to the first walkthrough; and
transmitting the supplementary stream to the second computing device of the user interacting with the first walkthrough, the second computing device operable to process the supplementary stream to perform one or both of:
playing the auditory content, and
displaying the visual content.

8. The system of claim 1, the one or more processors further operable to cause:
storing the first walkthrough as a data file in the database, the first walkthrough configured to be accessed via the data network and interacted with using a computing device.

9. The system of claim 1, the one or more processors further operable to cause:
generating a preview of the first walkthrough, the preview configured to be accessed via the data network and interacted with using the computing device; and
providing, to a third computing device, data capable of being processed by a processor of the third computing device to display a presentation of the preview, the presentation of the preview capable of being interacted with by a further user of the third computing device to validate or modify the walkthrough.

10. A method for streaming a walkthrough for an application or an online service, the method comprising:
maintaining, by one or more servers associated with a database system, a database storing data objects identifying walkthroughs and walkthrough stages, each walkthrough comprising a plurality of sequentially ordered walkthrough stages, each walkthrough stage configured to be displayed in a user interface at a computing device and each walkthrough stage comprising at least a portion of an interactive demonstration of a feature of the application or online service;
receiving a request from a first computing device of an author of a first walkthrough;
generating, based on the request, a first walkthrough stage of the first walkthrough, the first walkthrough stage comprising an interactive demonstration of a first feature of the application or online service;
causing display of, responsive to generating the first walkthrough stage, the first walkthrough stage in a first user interface at a second computing device of a user interacting with the first walkthrough;
receiving input from the second computing device;
determining, responsive to receiving the input from the second computing device, that the user has performed an interaction with the first feature; and
causing display of, responsive to determining that the user has performed the interaction with the first feature, a visual indicator in a second user interface at the first computing device, the visual indicator indicating that the user has performed the interaction with the first feature.

11. The method of claim 10, further comprising:
causing storage of, on the second computing device and responsive to determining that the user has performed the interaction with the first feature, data indicating that the user has performed the interaction with the first feature.

12. The method of claim 11, wherein the data indicating that the user has performed the interaction with the first feature is a component of an interaction history stored on the second computing device, the interaction history comprising further data indicating a history of a plurality of interactions with features of the application or online service.

13. The method of claim 12, further comprising:
determining that a first walkthrough session associated with the second computing device and one of the servers has been interrupted; and
causing restoration of, using the interaction history and responsive to determining that the first session has been interrupted, the first walkthrough session.

14. The method claim 10, further comprising:
storing, in the database, one or more data objects identifying a usage pattern associated with the user.

15. The method of claim 14, further comprising:
processing the usage pattern to generate analytic information indicating a summary of the usage pattern; and
causing display of a further visual indicator indicating the analytic information in the second user interface at the first computing device of the author of the walkthrough.

16. A computer program product comprising computer-readable program code to be executed by one or more processors when retrieved from a non-transitory computer-readable medium, the program code including instructions configured to cause:
maintaining, by one or more servers associated with a database system, a database storing data objects identifying walkthroughs and walkthrough stages, each walkthrough comprising a plurality of sequentially ordered walkthrough stages, each walkthrough stage configured to be displayed in a user interface at a computing device and each walkthrough stage comprising at least a portion of an interactive demonstration of a feature of the application or online service;
generating, based on a request received over a data network from a first computing device of an author of a first walkthrough, a first walkthrough stage of the first walkthrough, the first walkthrough stage comprising an interactive demonstration of a first feature of the application or online service;
displaying, responsive to generating the first walkthrough stage, the first walkthrough stage in a first user interface at a second computing device of a user interacting with the first walkthrough;
determining, responsive to receiving input over a data network from the second computing device, that the user has performed an interaction with the first feature; and
displaying, responsive to determining that the user has performed the interaction with the first feature, a visual indicator in a second user interface at the first computing device, the visual indicator indicating that the user has performed the interaction with the first feature.

17. The computer program product of claim 16, the instructions further configured to cause:
storing, on the second computing device and responsive to determining that the user has performed the interaction with the first feature, data indicating that the user has performed the interaction with the first feature.

18. The computer program product of claim 17, wherein the data indicating that the user has performed the interaction with the first feature is a component of an interaction history stored on the second computing device, the interaction history comprising further data indicating a history of a plurality of interactions with features of the application or online service.

19. The computer program product of claim 18, the instructions further configured to cause:
determining that a first walkthrough session associated with the second computing device and one of the servers has been interrupted; and
restoring, using the interaction history and responsive to determining that the first session has been interrupted, the first walkthrough session.

20. The computer program product of claim 16, the instructions further configured to cause:
storing, in the database, one or more data objects identifying a usage pattern associated with the user.
processing the usage pattern to generate analytic information indicating a summary of the usage pattern; and
displaying a further visual indicator indicating the analytic information in the second user interface at the first computing device of the author of the walkthrough.
